(19) United States
(12) Patent Application Publication
(10) Pub. No.: US 2007/0298860 A1
(43) Pub. Date: Dec. 27, 2007

(54) System and method of operating a gaming apparatus

(75) Inventors: Gordon Thomas Graves, Austin, TX (US); Jeremy L. Tyra, Austin, TX (US); Martin A. Keane, Chicago, IL (US)

Correspondence Address: TOLER SCHAFFER, LLP, 8500 BLUFFSTONE COVE, SUITE A201, AUSTIN, TX, 78759, US

(73) Assignee: Graves Management, Inc., Austin, TX (US)

(21) Appl. No.: 11/473,202

(22) Filed: Jun. 22, 2006

(51) Int. Cl. A63F 13/00

(52) U.S. Cl. 463/20

(57) ABSTRACT

The present disclosure is directed to a system and method of operating a gaming apparatus. In a particular embodiment, the method includes receiving a plurality of wagers made. The method also includes determining whether a prize event has occurred based on an outcome of a game play associated with the plurality of wagers made. Further, the method includes outputting prizes when the prize event occurs. Each of the prizes complies with a prize constraint limit, and a total value of the prizes is greater than a maximum per wager limit value. In addition, a totality of the prizes has a prize structure that is representative of a modeled prize structure of an apparatus that exceeds the prize constraint limit on a per wager basis.

### FIELD OF THE DISCLOSURE

The present disclosure relates generally to operating a gaming apparatus.

### BACKGROUND

Games of chance provide amusement for many individuals. Playing video arcade games and gambling with graphical and mechanical gaming apparatuses is a popular activity. In regulated jurisdictions, such games may also provide a revenue source for public programs. Some jurisdictions, however, place constraints on wagers that can be accepted and prizes that can be awarded by such apparatuses. These limits can deter individuals from using gaming machines, unless gaming providers can provide games that deal with these restraints by adopting game processes that create a winning experience similar to other popular games that do not need to comply with those restraints. Hence, there is a need for an improved system and method of operating a gaming apparatus.

### BRIEF DESCRIPTION OF THE DRAWINGS

FIG. 1 is a diagram of an example embodiment of a payout probability chart related to a gaming apparatus;

FIG. 2 is a diagram of an illustrative embodiment of a payout probability chart related to a gaming apparatus;

FIG. 3 is a general diagram of a particular illustrative embodiment of a gaming apparatus;

FIG. 4 is a block diagram of a particular illustrative embodiment of components of a gaming apparatus;

FIG. 5 is a block diagram of a particular illustrative embodiment of components of a gaming apparatus;

FIG. 6 is a flow diagram of a particular illustrative embodiment of a method of operating a gaming apparatus;

FIG. 7 is a flow diagram of a second particular embodiment of a method of operating a gaming apparatus;

FIG. 8 is a flow diagram of a third particular illustrative embodiment of a method of operating a gaming apparatus;

FIG. 9 is a diagram of an illustrative embodiment of nodes and links in a game play outcome; and

FIG. 10 is a diagram of an illustrative graphical user interface to display a game play outcome.

### DETAILED DESCRIPTION OF THE DRAWINGS

The disclosure is directed to a method of operating a gaming apparatus that includes accepting a very large plurality of wager contracts, each wager contract based on one of a plurality of separate outcomes that occur simultaneously. The method also includes determining whether a prize event has occurred based on the outcome of each game play associated with the plurality of wagers made. Further, the method includes outputting prizes when the prize event occurs. Each of the prizes complies with a prize constraint limit, and a total value of the prizes may be greater than a maximum per wager limit value. In addition, a totality of the prizes has a prize structure that is representative of a modeled prize structure of an apparatus that exceeds the prize constraint limit on a per wager basis.

In a particular illustrative embodiment, the method includes an optional insurance feature. The insurance feature option, when selected by a user, allows receipt of an insurance wager that adjusts the game play by limiting a player loss to a maximum player loss when the prize event does not occur and outputting additional prizes when the prize event occurs. In a particular implementation when the insurance option is selected by a player, the player may purchase the insurance such that the maximum bet is reduced by the cost of the insurance and the maximum price amount may be slightly reduced. The expected value of the prize amounts is reduced slightly for the player that purchases the insurance but the player that purchases the insurance does not have the same degree of potential downside losses.

The disclosure is directed to a method of operating a gaming apparatus that includes accepting a plurality of wagers. The method also includes determining whether a prize event has occurred based on an outcome of a game play associated with the plurality of wagers made. Further, the method includes outputting prizes when the prize event occurs. Each of the prizes complies with a prize constraint limit, and a total value of the prizes may be greater than a maximum per wager limit value. In addition, a totality of the prizes has a prize structure that is representative of a modeled prize structure of an apparatus that exceeds the prize constraint limit on a per wager basis.

The present disclosure is also directed to a gaming apparatus that includes a wager input device to receive a plurality of wagers made. The gaming apparatus may also include a processor and a memory device accessible to the processor, wherein the memory device includes instructions executable by the processor to determine whether a prize event has occurred based on an outcome of a game play associated with the plurality of wagers made. The memory device can also include instructions to output prizes via a prize output device when the prize event occurs. Each of the prizes complies with a prize constraint limit, and a total value the prizes may be greater than a maximum per wager limit value. Further, a totality of the prizes has a prize structure that is representative of a modeled prize structure of an apparatus that exceeds the prize constraint limit on a per wager basis.

In another embodiment, the disclosure is directed to a computer program embedded in a computer-readable medium. The computer program includes instructions to associate a plurality of wagers made with a game play, where the plurality of wagers made is received via a wager input device of a gaming apparatus. The computer program also includes instructions to determine whether a prize event has occurred based on an outcome of the game play. The computer program also includes instructions to output prizes via a prize output device of the gaming apparatus when the prize event occurs. Each of the prizes complies with a prize constraint limit, and a total value of the prizes may be greater than a maximum per wager limit value. In addition, a totality of the prizes has a prize structure that is representative of a modeled prize structure of an apparatus that exceeds the prize constraint limit on a per wager basis.

The present disclosure is also directed to a gaming apparatus that includes a wager input device to receive a plurality of wagers made. The gaming apparatus may also include a controller coupled to the wager input device. The controller determines whether a prize event has occurred based on an outcome of a game play associated with the plurality of wagers made. Additionally, the controller can output prizes via a prize output device when the prize event occurs. Each of the prizes complies with a prize constraint limit, and a total value of at least one of the prizes may be greater than a maximum per wager limit value. In addition, a totality of the prizes has a prize structure that is representative of a modeled prize structure of an apparatus that exceeds the prize constraint limit on a per wager basis.

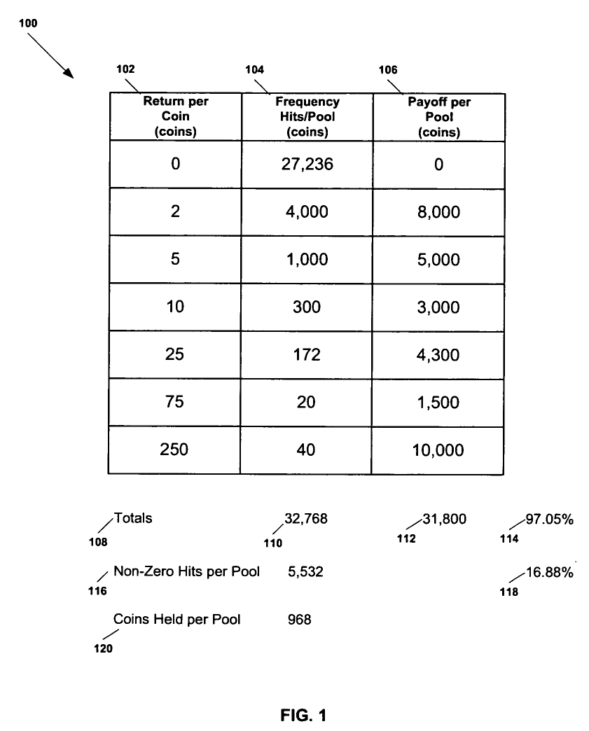

FIG. 1 illustrates an example embodiment of a payout probability chart 100 related to a modeled prize structure of a representative gaming machine that is not subject to prize constraint limits, such as a conventional single wager gaming machine (e.g., casino slot machine). The payout probability chart 100 illustrates various returns, such as a return per coin 102, for a plurality of possible outcomes of a game play. Further, the payout probability chart 100 illustrates a frequency 104 with which each such possible game play outcome occurs within a pool of available game plays 110. In addition, the payout probability chart 100 illustrates a payoff per pool column 106 that indicates how many coins are paid to players within a pool of game plays for each game play outcome.

For example, the payout probability chart 100 illustrates that the most likely outcome(s) of a game play yield zero coins and occur 27,236 times out of a pool of 32,768 game plays (i.e., 83.12%). In contrast, the payout probability chart 100 illustrates another outcome of a game play that yields two hundred fifty coins and occurs only 40 times out of a pool of 32,768 game plays (0.12%). These forty occurrences provide a payout of 10,000 coins per pool of game plays 110. Another outcome yields ten coins and occurs 300 times out of a pool of 32,768 game plays. These three hundred occurrences provide a total payout of 3,000 coins per pool of game plays. In total, the single wager gaming apparatus yields an average return 114 equal to 97.05% of the coins it receives. Game play outcomes that do not yield a zero return occur with a frequency 118 equal to 16.88%. Additionally, the coins held per pool 120 by the gaming apparatus is 968 for the 32,768 game plays.

In the example embodiment illustrated in FIG. 1, the prize structure includes a maximum output that occurs more frequently than a second highest output. The maximum prize occurs 40 times per pool, whereas the second highest output occurs 20 times per pool. This prize structure can contribute to player excitement and encourage game play, by paying off more ‘jackpot’ amounts than second prizes.

In some jurisdictions, the prize structure illustrated in FIG. 1 may not be realizable under certain regulations for a single wager machine. For instance, some jurisdictions limit gaming machine prizes to no more than ten times any single wager. In addition, some jurisdictions limit gaming machines to a maximum per wager limit value, such as a maximum per wager limit value of five dollars. The prize structure illustrated in FIG. 1 provides several outcomes that return more than a multiple of ten times the single wager and several outcomes that can return more than five dollars for a single wager, depending on the value of coins returned. Hence, a single wager gaming machine having the prize structure illustrated in FIG. 1 cannot be used in such jurisdictions.

Game operators in regulated jurisdictions need to provide games that comply with the jurisdictions' prize constraint limits yet can compete with game machines that are not subject to such restrictions. The system and method disclosed provide operation of a gaming apparatus that complies with prize constraint limits and provides prize structures that replicate or are based on modeled prize structures of single wager gaming machines that do not comply with the prize constraint limits. In one embodiment, the gaming apparatus can provide such a prize structure using a plurality of wagers and a guaranteed non-zero return.

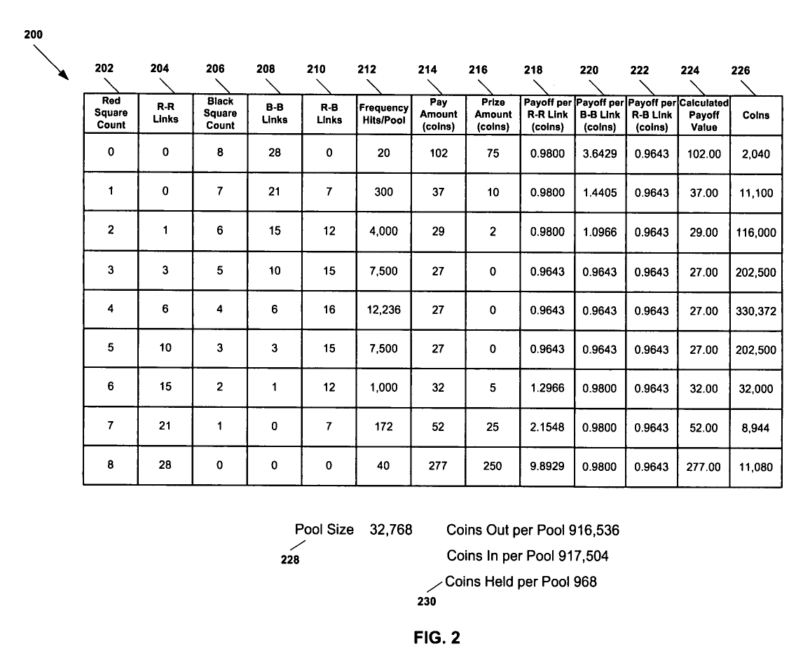

FIG. 2 illustrates an example of a payout probability chart 200 related to a prize structure of an illustrative embodiment of a novel multi-wager gaming apparatus as provided herein. The novel multi-wager gaming apparatus complies with a prize constraint limit while emulating a modeled prize structure of a gaming apparatus that does not comply with the prize constraint limit, such as the prize structure illustrated in FIG. 1. In a particular embodiment, the payout probability chart 200 may be associated with an exemplary game, in which squares are given one of a first color and a second color as an outcome of a game play. In an illustrative embodiment, there are eight such squares with twenty-eight links between pairs of these squares. The squares are given one of two colors, and the links are classified depending on whether a link connects two squares of the first color (R-R links 204 in FIG. 2), two squares of the second color (B-B links 208 in FIG. 2), or one square of the first color and one square of the second color (R-B links 210 in FIG. 2).

In a particular embodiment, a plurality of wagers is associated with a game play, such as one coin wagered on each of the twenty-eight links. Pay amounts 214 can be calculated based on a payoff per link of each color or type. As illustrated, the payout probability chart 200 includes a payoff per red square-to-red square (R-R) link column 218 that illustrates the coins paid per wager for each R-R link in a game play outcome. Additionally, the payout probability chart 200 includes a payoff per black square-to-black square (B-B) link column 220 that illustrates the coins paid per wager for each B-B link in a game play outcome. The payout probability chart 200 also includes a payoff per red square-to-black square (R-B) link column 222 that illustrates the coins paid per wager for each R-B link in a game play outcome. The payout probability chart 200 also includes a calculated payoff value column 224 that illustrates a calculated payoff figure related to each game play outcome. Further, the payout probability chart 200 includes a total coins column 226 that illustrates a number of coins output per pool of game plays for each possible game play outcome.

As illustrated in FIG. 2, the example payout probability chart 200 includes a plurality of possible game play outcomes. Each game play outcome includes a number of red squares 202, a number of links between red squares 204, a number of black squares 206, a number of links between black squares 208, and a number of links between red and black squares 210. For instance, a first game play outcome can include zero red squares, eight black squares, and twenty-eight B-B links. In one example, a first game play outcome can include zero red squares, eight black squares, and twenty-eight black square-to-black square (B-B) links. The pay amount 214 for this game play outcome can be calculated by summing the products of multiplying the payoff per R-R link related to the game play outcome by the number of R-R links; of multiplying the payoff per B-B link related to the game play outcome by the number of B-B links; and of multiplying the payoff per R-B link related to the game play outcome by the number of R-B links:

(0.9643×0)+(3.6429×28)+(0.9643×0)=102.00

The calculated payoff value 224 (i.e., 102.00 coins) can be rounded to the next highest, next lowest, or nearest number of coins to produce the pay amount 214. Hence, the pay amount 214 for this game play outcome can be 102 coins.

In another example, the game play outcome can include five red squares, three black squares, ten R-R links, three B-B links, and fifteen eight R-B links. The pay amount 214 for this game play outcome can be calculated by summing the products of multiplying the payoff per R-R link related to the game play outcome by the number of R-R links; of multiplying the payoff per B-B link figure related to the game play outcome by the number of B-B links; and of multiplying the payoff per R-B link figure related to the game play outcome by the number of R-B links. The calculated payoff value for such a game play outcome is:

(0.9643×10)+(0.9643×3)+(0.9643×15)=27.00

### Hence, the pay amount 214 for this game play outcome can be 27 coins.

Another game play outcome can include eight red squares, zero black squares, and twenty-eight R-R links. The pay amount 214 for this game play outcome can be calculated by summing the products of multiplying the payoff per R-R link related to the game play outcome by the number of R-R links; of multiplying the payoff per B-B link related to the game play outcome by the number of B-B links; and of multiplying the payoff per R-B link related to the game play outcome by the number of R-B links:

(9.8929×28)+(0.9800×0)+(0.9643×0)=277.00

### Hence, the pay amount 214 for this game play outcome can be 277 coins.

Various game play outcomes are possible, each having a distribution of red squares, black squares, R-R links, B-B links, R-B links, or any combination thereof. The payout probability chart 200 includes a frequency of each game play outcome, such as a number of times 212 that each game play outcome occurs within a pool of game plays 220. In addition, the payout probability chart 200 includes pay amounts 214 associated with each game play outcome, such as a number of coins, or credits, output to a player when the game play outcome occurs. The payout probability chart 200 also includes modeled prize amounts 216 associated with each game play outcome, such as a number of coins or credits that can be mapped from the modeled prize structure illustrated in FIG. 1 to the prize structure illustrated in FIG. 2.

The prize structure illustrated in FIG. 2 is representative of a modeled prize structure of a gaming apparatus that is not subject to a prize constraint limit, such as that illustrated in FIG. 1. For example, game play outcomes having three, four, or five red squares occur 27,236 times out of a pool of 32,768 game plays. Likewise, a game play outcome having eight red squares occurs 40 times out of a pool of 32,768 game plays. A game play outcome having one red square occurs 300 times out of a pool of 32,768 game plays. Further, the coins held per pool of game plays 230 is equal to 968, even though each of the game plays in the pool is associated with twenty-eight coins, rather than a single wager. In an illustrative embodiment, the prize structure illustrated in FIG. 2 can replicate the modeled prize structure of a gaming apparatus that is not subject to a prize constraint limit.

Despite resembling the prize structure illustrated in FIG. 1, the prize structure illustrated in the payout probability chart 200 in FIG. 2 complies with a prize constraint limit that restricts prizes to a multiple of ten times any single wager. The gaming apparatus accomplishes this using multiple wagers. For example, in the exemplary embodiment illustrated in FIG. 2, a game play outcome that returns a highest pay amount of two hundred seventy-seven coins is less than ten times the twenty-eight coins wagered during the game play, as a whole and for any single wager (i.e., 9.8929 is less than 10). In a particular embodiment, the pay amount 214 associated with each game play outcome could be viewed as twenty-eight prizes, each prize associated with one of the twenty-eight wagers and equaling less than ten times the associated wager.

Though an example of a game using twenty-eight wagers is described herein, those skilled will readily appreciate that many alternative embodiments of a multiple-wager game can be used to comply with a prize constraint limit, yet provide a prize structure that is representative of or replicates a modeled prize structure of a gaming apparatus that does not comply with the prize constraint limit. Moreover, the nature of the game in terms of colors, shapes, links, objectives, game play outcomes, distributions of outcomes, and the like are not essential aspects of such multiple-wager games. Those skilled in the art will readily appreciate that many embodiments of games can be conducted using a gaming apparatus in a way that complies with a prize constraint limit, yet provides a prize structure that is representative of or replicates a modeled prize structure of a gaming apparatus that does not comply with the prize constraint limit.

In addition, the prize structure described herein can be modified. In an illustrative, non-limiting embodiment, a prize structure can be selected from a plurality of prize structures. For example, a game operator or administrator can select a prize structure from a first modeled prize structure, such as the prize structure illustrated in FIG. 2; a second modeled prize structure, such as a prize structure having only one prize event; another modeled prize structure; an arbitrary prize structure; or any combination thereof. In another particular embodiment, a player may be presented with an option to select the prize structure followed by the gaming apparatus during a game play.

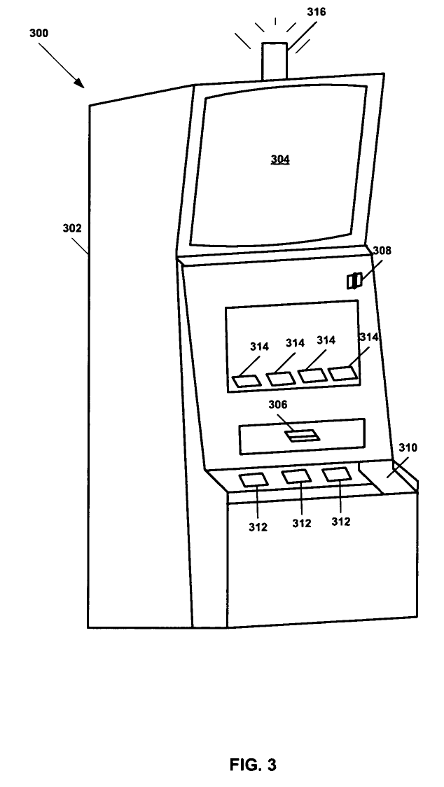

Referring to FIG. 3, an illustrative embodiment of a gaming apparatus is illustrated and is generally designated 300. The apparatus 300 includes a housing 302 that encloses or supports various components of the apparatus 300. In a particular embodiment, the housing 302 can be a unitary or multi-part chassis that is composed of metal, plastic, fiberglass, other suitable materials, or any combination thereof. The apparatus 300 includes a display device 304 that displays a game and information related to the game. In an illustrative embodiment, the display device 304 can be a video display screen that displays a game and information related to the game via a graphical user interface. The display screen can include a cathode ray tube (CRT), liquid crystal display (LCD), plasma screen, touch-screen, or any other display technology suitable to display a game.

As illustrated in FIG. 3, the apparatus 300 includes one or more wager input devices and one or more output devices. For example, the apparatus 300 can include a card reading device 306 that is configured to read cards having magnetic strips or portions, such as drivers licenses, credit cards, debit cards, gift cards, retailer cards, and the like. In an illustrative embodiment, a card having a magnetic strip or portion can be swiped through or otherwise read by the card reading device 306, and the card reading device 306, or a controller or computing device coupled thereto, can access an account associated with the card. Wagers can be received from the account by the apparatus 300, and prizes can be deposited to the account by the apparatus 300.

In another particular embodiment, the card-reading device 306 can be configured to read information from, and write information to, an integrated circuit card, such as a “smart card.” For instance, a card that includes an integrated circuit, computer chip, or other data storage device, can be swiped through or otherwise read by the card-reading device 306. The card-reading device 306, or a computing device coupled thereto, can read account data, identification data, or other data stored by the card. Wagers can be received at the apparatus 300 from an account associated with the card, and prizes and other payout amounts can be deposited to the account by the apparatus 300. In an illustrative embodiment, the card reader 306 can write information to the card that reflects a change in account information.

In a particular embodiment, the wager input devices of the apparatus 300 can include a coin receipt device 308 configured to receive coins. In an illustrative embodiment, the coin receipt device 308 can be configured to receive United States quarters. In another illustrative embodiment, the coin receipt device 308 can be configured to receive United States pennies, United States nickels, United States half dollars, United States dollar coins, foreign currency coins, or any combination thereof.

In another particular embodiment, the gaming apparatus 300 can include a coin output portion 310 configured to output coins as prizes and other payout amounts as a result of a game play at the apparatus 300. In an illustrative embodiment, the apparatus 300 can be configured to output United States quarters via the coin output portion 310. In another illustrative embodiment, the apparatus 300 can be configured to output United States pennies, United States nickels, United States half dollars, United States dollar coins, foreign currency coins, or any combination thereof, via the coin output portion 310. In an illustrative embodiment, the coin output portion 310 can be configured to hold coins until they are collected. In another illustrative embodiment, the coin output portion 310 can be configured to allow coins to slide out of contact with the apparatus 300, for example, into a container used by a player to hold coins.

In a particular embodiment, the gaming apparatus 300 can include one or more control buttons 312. For example, the control buttons 312 can include a ‘START’ button or a similar button that a user can select to begin a gaming session or otherwise indicate that the user desires to play a game at the apparatus 300. Further, the control buttons 312 can include an ‘END’ button or a similar button that a user can select to stop a gaming session or otherwise indicate that the user no longer desires to play games at the apparatus 300. In an illustrative embodiment, the control buttons 312 can include one or more buttons that a user can select to indicate whether the user desires to place wagers using the card reading device 306 or the coin insertion device 308.

Further, the gaming apparatus 300 can include one or more game play buttons 314. For example, the game play buttons 314 can include a ‘PLAY’ button or similar button that a user can select to indicate that the user desires a game play to start. Further, the game play buttons 314 can include a ‘STOP’ button or similar button that a user can select to stop a randomization process, for instance, and have the apparatus 300 display a game play outcome based on the process at the point at which the user stopped the game. Alternatively, a game play can stop as determined by the apparatus 300 without a player selecting a ‘STOP’ control.

In addition, the game play buttons 314 can include a ‘HELP’ button or similar button that a user can select to cause the apparatus 300 to display information about the game, operation of the apparatus 300, wagering, other information to help a user to play games at the apparatus 300, or any combination thereof. In an illustrative embodiment, the game play buttons 314 can include a ‘PAYTABLE’ button or similar button that a user can select to cause the apparatus 300 to display information related to potential prizes, probabilities of potential prizes, other information related to game plays at the apparatus 300, or any combination thereof.

In an illustrative, non-limiting embodiment, the control buttons 312, the game play buttons 314, or any combination thereof, can be located separately or together on the apparatus 300. Moreover, the control buttons 312, the game play buttons 314, or any combination thereof, can be touch-screen buttons operated via the display device 304.

In a particular embodiment, the apparatus 300 can include a prize event indication device 316, such as a light, siren, bell, other audio or visual prize event indicator, or any combination thereof, configured to indicate that a prize event has occurred at the apparatus 300.

The various components of the gaming apparatus 300 illustrated in FIG. 3 can communicate with a controller that causes the gaming apparatus 300 to execute and implement the various functions of the controls, input and output devices, display portions, and indicator devices. Alternatively, the various components can communicate with a processor that implements the various functions according to computer-readable instructions in a memory device accessible the processor.

In a particular embodiment, the apparatus 300 can receive a plurality of wagers from a player. For example, the wagers can be received from a player account after the apparatus 300 reads a card having a magnetic strip or data storage portion via the card-reading device 306. In another example, the player can insert a plurality of coins via the coin receipt device 308. In an illustrative embodiment, the apparatus 300 can begin receiving wagers after a control button 312, such as a ‘START’ button is selected by the player. Further the apparatus 300 can determine whether it has received a number or total value of wagers required to play a game. The apparatus 300 can prompt the player via the display device 304 or other device to input additional wagers, if the required number or value of wagers has not been received.

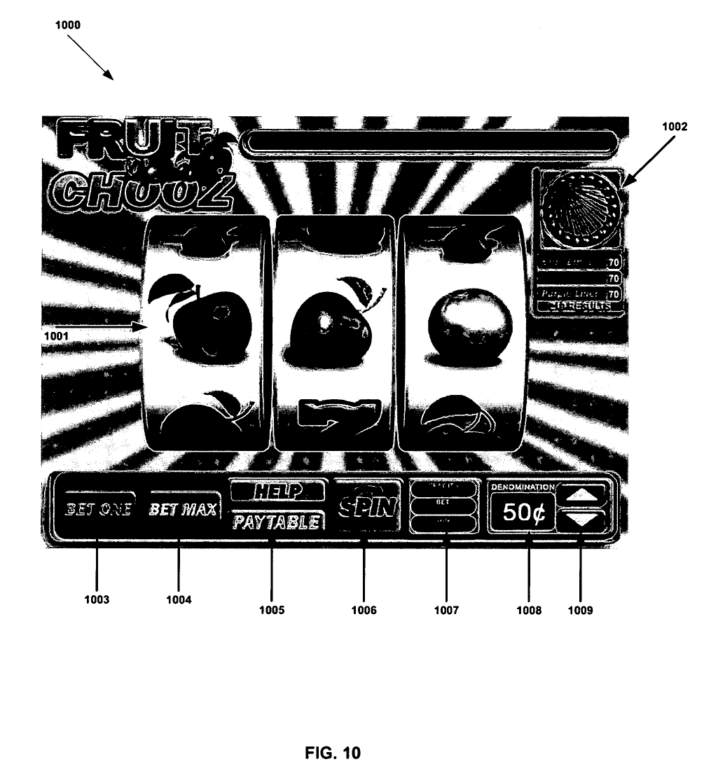

After the apparatus 300 has received a required number or value of wagers, the apparatus 300 can initiate a game play associated with the plurality of wagers. In an illustrative embodiment, the apparatus 300 can start the game play automatically on receipt of the required wagers, or the player can indicate a desire to start the game play by selecting one or more of the game play buttons 314, such as a ‘PLAY’ button or similar button. The apparatus 300 can determine an outcome of the game play and display the outcome at the display device 304 via a user interface. An example of such a user interface is illustrated in FIG. 10.

In a particular embodiment, the gaming apparatus 300 can determine whether a prize event has occurred, based on the game play outcome. If a prize event has occurred, the gaming apparatus 300 can output prizes, such as one or more coins, via the coin output portion 310. In another embodiment, when a prize event has occurred, the gaming apparatus 300 can output the value of prizes to a player account associated with a card that has been swiped or read at the card-reading device 306.

In an illustrative embodiment, a prize event can be one of a plurality of prize events. The values of prizes associated with separate prize events, or with separate groups of prize events, can vary, such that not all prize events output prizes of equal value. Further, the plurality of prize events can include at least one special prize event, such as one or more ‘jackpot’ prize events. In an exemplary embodiment, the gaming apparatus 300 can output prizes regardless of the game play outcome, such that the gaming apparatus 300 has a guaranteed non-zero return.

In a particular embodiment, the prizes output by the gaming apparatus 300 comply with a prize constraint limit. In an illustrative embodiment, the prize constraint limit can limit the value of the prizes to a maximum multiple of the value of each of the plurality of wagers, such as a multiple of ten. Nonetheless, the gaming apparatus 300 can provide a prize structure that is representative of a modeled prize structure of an apparatus that does not comply with the prize constraint limit, such as a single wager gaming apparatus having a modeled prize structure that is not realizable by a single wager gaming apparatus within the prize constraint limit. In one embodiment, the gaming apparatus 300 can provide such a prize structure using a plurality of wagers and a guaranteed non-zero return.

For example, the gaming apparatus 300 can require twenty-eight coins for a game play, each of the coins representing a separate wager associated with the game play. The prizes output by the gaming apparatus can have a prize structure such as that illustrated in FIG. 2. Thus, when the gaming apparatus 300 outputs its highest output of two hundred seventy-seven quarters, the gaming apparatus 300 returns fewer than ten coins for any single wager. Nonetheless, the frequencies of particular prizes output by the gaming apparatus 300 within a pool of game plays and the coins retained by the gaming apparatus 300 per pool of game plays resembles the prize structure of a gaming apparatus that is not subject to the prize constraint limit, such as the prize structure illustrated in FIG. 1.

In an illustrative embodiment, the structure of prizes output by the gaming apparatus 300 can resemble that of a single wager gaming apparatus having the modeled prize structure illustrated in FIG. 1, when the gaming apparatus provides a non-zero return equal to all but one of the wagers associated with a game play. For instance, one or more particular game play outcomes can output a pay amount of twenty-seven coins. Hence, the totality of prizes output by the gaming apparatus 300 can have a prize structure that is representative of a modeled prize structure of a single wager gaming apparatus having a modeled prize structure such as that illustrated in FIG. 1, yet none of the prizes output by the gaming apparatus 300 exceeds the prize constraint limit of ten times any single wager.

In an illustrative embodiment, the prizes output by the gaming apparatus 300 can also comply with a maximum per wager limit value that restricts the value of prizes returned by the gaming apparatus 300 for any single wager. For example, the maximum per wager limit value can limit prizes output by the gaming apparatus 300 to a maximum value of five dollars ($5.00), per wager. When a game play outcome occurs that is associated with pay amounts totaling one hundred two quarters or two hundred seventy-seven quarters, for instance, the total value of the prize exceeds five dollars, but the prize does not exceed the maximum per wager limit value of five dollars for any single wager.

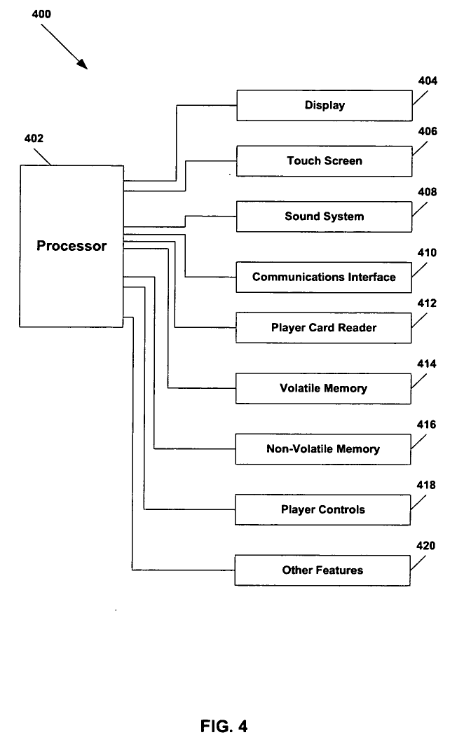

Referring to FIG. 4, a particular embodiment of components of a gaming apparatus is illustrated and designated generally 400. The apparatus 400 includes a processor 402 that communicates with various components, modules and systems of the apparatus 400. For example, the processor 402 can communicate with a display system 404 that includes a display screen, a video controller, one or more user interface modules, other devices to display components, or any combination thereof. In an illustrative, non-limiting embodiment, the processor 402 can communicate with a touch-screen system 406 to display game play and other information to a user and to receive commands from the user via a touch-screen user interface.

In a particular embodiment, the processor 402 can communicate with a sound system 408. The sound system 408 can include one or more speakers, amplifiers, audio files, other devices and modules to output audio associated with game play, or any combination thereof. Further, the processor 402 can communicate with one or more communications interfaces 410. The communications interface(s) 410 can include a telephone interface, a cable interface, a power line interface, an Ethernet interface, a digital subscribe line interface, a fiber line interface, other network interface, or any combination thereof. In an illustrative embodiment, the processor 402 can communicate via the communications interface(s) 410 with information sources, such as user accounts, user identification or information stores, prohibited player databases, on-site or off-site security systems, system administration devices, other information or control sources accessible via a communications network, or any combination thereof.

In a particular embodiment, the processor 402 can communicate with a player card reader 412. The player card reader 412 can be configured to read cards having magnetic strips or portions, such as drivers licenses, credit cards, debit cards, gift cards, or retailer cards; to read information from, and write information to, an integrated circuit card, such as a “smart card;” or any combination thereof. In an illustrative embodiment, a card can be swiped through or otherwise read via the player card reader 412, and the processor 402 or other component of the apparatus 400 can access an account associated with the card via the communications interface(s) 410. Wagers can be received from the account by the apparatus 400, and prizes and other payout amounts can be deposited to the account by the apparatus 400.

In addition, the processor 402 can communicate with one or more volatile memory devices 414. The volatile memory device(s) 414 can include a static random-access memory (SRAM) device, a dynamic random-access memory (DRAM) device, a ferroelectric random-access memory (FRAM) device, or any combination thereof. The volatile memory device(s) 414 can be configured to store data related to game play, user interfaces, video displays, touch-screen operation, user-requested information, and other data that is temporarily required to provide information, function, control, display, game play, or any combination thereof, during a particular use of the apparatus 400 or in between particular uses.

Further, the processor 402 can communicate with one or more non-volatile memory devices 416, such as read-only memory (ROM), programmable read-only memory (PROM), erasable programmable read-only memory (EPROM), electrically erasable programmable read-only memory (EEPROM), battery-powered random access memory, flash memory, or any combination thereof. The non-volatile memory device(s) 416 can be configured to store data related to operating systems, game play, user interfaces, video displays, touch-screen operation, user-requested information, and other data that is to remain stored at the apparatus 400 after powering off, including data required to provide information, function, control, display, game play, or any combination thereof, during all uses of the apparatus 400 and in between uses.

In a particular embodiment, the processor 402 can communicate with one or more player controls 418. For example, the processor 402 can communicate with control buttons and game play buttons, such as the buttons illustrated at 112 and 114 in FIG. 1. In another embodiment, the processor 402 can communicate with one or more joysticks, microphones, keys, switches, other input devices, or any combination thereof. In an illustrative, non-limiting embodiment, the one or more of the player controls can include selectable touch-screen icons, buttons or other video features operated via a touch-screen system 406.

In an illustrative embodiment, the processor 402 can communicate with other features 420 of the apparatus 400, such as coin input and output devices, paper currency input and output devices, various modules or computer instructions executable by the processor 402 to implement game play, user interfaces, display, wager receipt, prize output, or other functions associated with use of the apparatus 400.

In a particular embodiment, the apparatus 400 can receive a plurality of wagers from a player. For example, the wagers can be received from a player account accessed by the apparatus 400 via the communications interface(s) 410 after the

processor 402 reads a card having a magnetic strip or data storage portion with the player card reader 412. In another example, the player can insert coins into a coin input device of the apparatus 400. In an illustrative embodiment, the apparatus 400 can begin receiving wagers after the processor 402 determines that a player control 418, such as a ‘START’ control displayed via a touch-screen system 406, is selected by the player. In an illustrative embodiment, the volatile memory 414, non-volatile memory 416, or any combination thereof, can include instructions executable by the processor 402 to determine whether the apparatus 400 has received a number or total value of wagers required to play a game. The volatile memory 414, non-volatile memory 416, or any combination thereof, can include instructions executable by the processor 402 to prompt the player via the display device 404 or other device to input additional wagers, if the required number or value of wagers has not been received.

After the apparatus 400 has received a required number or value of wagers, the processor 402 can execute instructions in the volatile memory 414, non-volatile memory 416, or any combination thereof, to initiate a game play associated with the plurality of wagers. In an illustrative embodiment, the processor 402 can start the game play automatically on receipt of the required wagers, or the player can indicate a desire to start the game play by selecting one or more of the player controls 418, such as a ‘PLAY’ button or similar button. The processor 402 can determine an outcome of the game play and display the outcome at the display device 404 via a user interface. An example of such a user interface is illustrated in FIG. 10.

In a particular embodiment, the processor 402 can determine whether a prize event has occurred, based on the game play outcome. If a prize event has occurred, the processor 402 can cause a coin output device to output prizes, such as one or more coins. In another embodiment, the processor 402 can cause the value of prizes to be returned to a player account associated with a card that has been swiped or read via the player card reader 412.

In an illustrative embodiment, a prize event can be one of a plurality of prize events. The values of prizes associated with separate prize events, or with separate groups of prize events, can vary, such that not all prize events output prizes of equal value. Further, the plurality of prize events can include at least one special prize event, such as one or more ‘jackpot’ prize events. In an exemplary embodiment, the gaming apparatus 400 can output prizes regardless of the game play outcome, such that the gaming apparatus 400 has a guaranteed, non-zero return.

In a particular embodiment, the prizes output by the gaming apparatus 400 comply with a prize constraint limit. In an illustrative embodiment, the prize constraint limit can limit the value of the prizes to a maximum multiple of the value of each of the plurality of wagers, such as a multiple of ten. Nonetheless, the gaming apparatus 400 can provide a prize structure that is representative of a modeled prize structure of an apparatus that does not comply with the prize constraint limit, such as a single wager gaming apparatus having a modeled prize structure that is not realizable by a single wager gaming apparatus within the prize constraint limit. In one embodiment, the gaming apparatus 400 can provide such a prize structure using a plurality of wagers and a guaranteed non-zero return.

For example, the gaming apparatus 400 can require twenty-eight coins for a game play, each of the coins representing a separate wager associated with the game play. The prizes output by the gaming apparatus can have a prize structure such as that illustrated in FIG. 2. Thus, when the gaming apparatus 400 outputs its highest output of two hundred seventy-seven quarters, the gaming apparatus 400 returns fewer than ten coins for any single wager. Nonetheless, the frequencies of particular prizes output by the gaming apparatus 400 within a pool of game plays and the coins retained by the gaming apparatus 400 per pool of game plays resembles the prize structure of a gaming apparatus that is not subject to the prize constraint limit, such as the prize structure illustrated in FIG. 1.

In an illustrative embodiment, the structure of prizes output by the gaming apparatus 400 can resemble that of a single wager gaming apparatus having the modeled prize structure illustrated in FIG. 1, when the gaming apparatus provides a non-zero return equal to all but one of the wagers associated with a game play. For instance, one or more particular game play outcomes can output a pay amount of twenty-seven coins. Hence, the totality of prizes output by the gaming apparatus 400 can have a prize structure that is representative of a modeled prize structure of a single wager gaming apparatus having a modeled prize structure such as that illustrated in FIG. 1, yet none of the prizes output by the gaming apparatus 400 exceeds the prize constraint of ten times any single wager.

In an illustrative embodiment, the prizes output by the gaming apparatus 400 can also comply with a maximum per wager limit value that restricts the value of prizes returned by the gaming apparatus 400 for any single wager. For example, the maximum per wager limit value can limit prizes output by the gaming apparatus 400 to a maximum value of five dollars ($5.00), per wager. When a game play outcome occurs that is associated with pay amounts totaling one hundred two quarters or two hundred seventy-seven quarters, for instance, the total value of the prize exceeds five dollars, but the prize does not exceed the maximum per wager limit value of five dollars for any single wager.

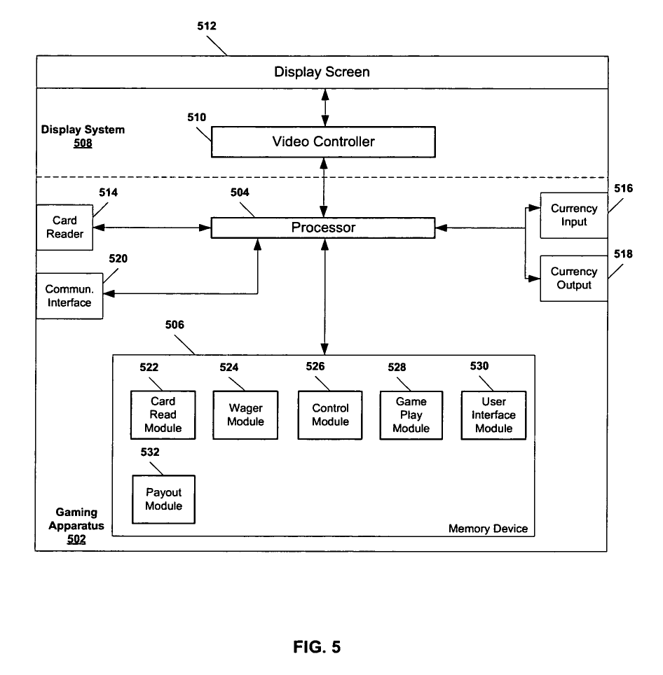

Referring to FIG. 5, a particular embodiment of components of a gaming apparatus is illustrated and designated generally at 502. The apparatus 502 includes a processor 504 that communicates with various components, modules and systems of the apparatus 502. The apparatus 502 also includes at least one memory device 506 accessible to the processor 504. Further, the processor 504 can communicate with a display system 508 that includes a video controller 510 to process data and display related video and information via a display screen 512.

In a particular embodiment, the processor 504 can communicate with a card reader 514. The card reader 514 can be configured to read cards having magnetic strips or portions, such as drivers licenses, credit cards, debit cards, gift cards, or retailer cards; to read information from, and write information to, an integrated circuit card, such as a “smart card;” or any combination thereof. In an illustrative embodiment, a card can be swiped through or otherwise read via the card reader 514, and the processor 504 or other component of the apparatus 502 can access an account associated with the card. Wagers can be received from the account by the apparatus 502, and prizes and other payout amounts can be deposited to the account by the apparatus 502.

In another particular embodiment, the processor 504 can communicate with one or more currency input devices 516. In an illustrative embodiment, the currency input device(s) 516 can include a coin receipt device, a paper currency receipt device, or any combination thereof. In addition, the processor can communicate with one or more currency output devices 518, such as a coin output device, a paper currency output device, or any combination thereof.

In an illustrative embodiment, the processor 504 can communicate with one or more communications interfaces 520. The communications interface(s) 520 can include a telephone interface, a cable interface, a power line interface, an Ethernet interface, a digital subscribe line interface, a fiber line interface, other network interface, or any combination thereof. In an illustrative embodiment, the processor 504 can communicate via the communications interface(s) 520 with information sources, such as user accounts, user identification or information stores, prohibited player databases, on-site or off-site security systems, system administration devices, other information or control sources accessible via a communications network, or any combination thereof.

In a particular embodiment, the gaming apparatus 502 can receive a plurality of wagers from a player. For example, the wagers can be received from a player account accessed by the gaming apparatus 502 via the communications interface(s) 520 after the gaming apparatus has read a card having a magnetic strip or data storage portion via the player card reader 514. In an illustrative embodiment, the memory device 506 includes a card read module 522 that is executable by the processor 504 to read a magnetic strip or data storage portion of the card and to access account information via the communication interface(s) 520. In another example, the player can insert coins or paper bills via the currency input device(s) 516.

In an illustrative embodiment, the gaming apparatus 502 can begin receiving wagers after a player control, such as a ‘START’ button of the apparatus or a similar control displayed via a touch-screen system, is selected by the player. In an illustrative embodiment, the memory device 506 can include a control module 526 executable by the processor 504 to determine that the gaming apparatus 502 has received such a selection. Further, the memory device 506 can include a wager module 524 executable by the processor 504 to determine whether the gaming apparatus 502 has received a number or total value of wagers required to play a game. The wager module 524 can be executable by the processor 504 to prompt the player via the display system 508 or other device to input additional wagers, if the required number or value of wagers has not been received.

After the gaming apparatus 502 has received a required number or value of wagers, the gaming apparatus can initiate a game play associated with the wagers. In an illustrative embodiment, the memory device 506 can include a game play module 528 executable by the processor 504 to start a game play automatically on receipt of the required wagers, or in response to a player selecting one or more player controls, such as a ‘PLAY’ button or similar button. In a particular embodiment, the game play module 528 can be executable by the processor 504 to determine a game play outcome according to pre-determined frequencies associated with each possible game play outcome within a pool of game plays.

In a particular embodiment, the memory device 506 can include a user interface module 530 executable by the processor 504 to display the outcome of the game play via the display system 508. Further, the user interface module 530 can be executable by the processor 504 to display the game play via the display system 508. In addition, the user interface module 530 can be executable by the processor 504 to display payout tables, help information, advertising information, explanations of the game, other information, or any combination thereof, via the display system 508. In an illustrative embodiment, the user interface module 530 can be executable by the processor 504 to display information in response to selections of various buttons, touch-screen controls, or other controls.

In a particular embodiment, the game play module 528 can be executable by the processor 504 to determine whether a prize event has occurred, based on the game play outcome. The memory device 506 can include a payout module 532 executable by the processor to cause the gaming apparatus 502 to output a prize when a prize event has occurred. For example, if a prize event has occurred, the payout module 532 can be executable by the processor 504 to cause a currency output device to output a prize, such as one or more coins, paper bills, or any combination thereof. In another embodiment, the payout module 532 can be executable by the processor 504 to cause the value of one or more coins, paper bills, or any combination thereof, to be output to a player account associated with a card that has been swiped or read via the card reader 514. In one embodiment, the payout module 532 can be executable by the processor 504 to calculate prizes or pay amounts according to formulae stored in the memory device 506.

In an illustrative embodiment, a prize event can be one of a plurality of prize events. The values of prizes associated with separate prize events, or with separate groups of prize events, can vary, such that not all prize events output prizes of equal value. Further, the plurality of prize events can include at least one special prize event, such as one or more ‘jackpot’ prize events. In an exemplary embodiment, the payout module 532 can be executable by the processor 504 to output prizes regardless of the game play outcome, such that the gaming apparatus 502 has a guaranteed, non-zero return.

In a particular embodiment, the payout module 532 can be executable by the processor 504 to limit each of the prizes output by the gaming apparatus 502 according to a prize constraint limit, such as a multiple of ten times any single wager. Nonetheless, the gaming apparatus 502 can provide a prize structure that is representative of a modeled prize structure of an apparatus that does not comply with the prize constraint limit, such as a single wager gaming apparatus having a modeled prize structure that is not realizable by a single wager gaming apparatus within the prize constraint limit. In one embodiment, the gaming apparatus 502 can provide such a prize structure using a plurality of wagers and a guaranteed non-zero return.

For example, the wager module 524 can be executable by the processor 504 to require twenty-eight coins for a game play, each of the coins representing a separate wager associated with the game play. The payout module 532 can be executable by the processor 504 to output prizes according to a prize structure such as that illustrated in FIG. 2. Thus, when the gaming apparatus 502 outputs its highest output of two hundred seventy-seven quarters, the gaming apparatus 502 returns fewer than ten coins for any single wager. Nonetheless, the frequencies of particular prizes output by the gaming apparatus 502 within a pool of game plays and the coins retained by the gaming apparatus 502 per pool of game plays resembles the prize structure of a gaming apparatus that is not subject to the prize constraint limit, such as the prize structure illustrated in FIG. 1.

In an illustrative embodiment, the payout module 532 can be executable by the processor 504 to calculate the prizes by applying formulae stored in the memory device 506 to a game play outcome, such as a payoff per link of each type multiplied by the number of links of each type.

In an illustrative embodiment, the structure of prizes output by the gaming apparatus 502 can resemble that of a single wager gaming apparatus having the prize structure illustrated in FIG. 1, when the payout module 532 is executable by the processor 504 to output a non-zero return equal to all but one of the plurality of wagers associated with a game play. For instance, one or more particular game play outcomes can output a pay amount of twenty-seven coins. Hence, the totality of prizes output by the gaming apparatus 502 can have a prize structure that is representative of a modeled prize structure of a single wager gaming apparatus having a modeled prize structure such as that illustrated in FIG. 1, yet none of the prizes output by the gaming apparatus 502 exceeds the prize constraint of ten times any single wager.

In an illustrative embodiment, the payout module 532 can be executable by the processor 504 to output prizes that comply with a maximum per wager limit value that restricts the value of prizes returned by the gaming apparatus 502 for any single wager. For example, the maximum per wager limit value can limit prizes output by the gaming apparatus 502 to a maximum value of five dollars ($5.00), per wager. When a game play outcome occurs that is associated with pay amounts totaling one hundred two quarters or two hundred seventy-seven quarters, for instance, the total value of the prize exceeds five dollars, but the prize does not exceed the maximum per wager limit value of five dollars for any single wager.

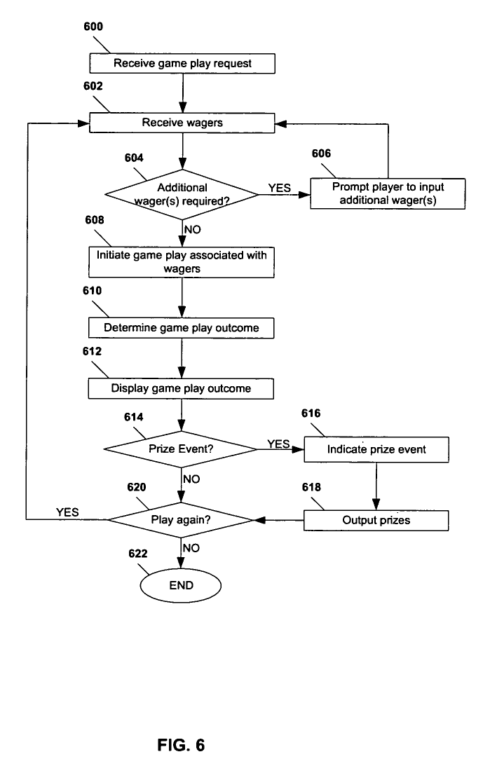

Referring to FIG. 6, a particular embodiment of a method of operating a gaming apparatus is illustrated. At block 600, a request is received at a gaming apparatus to initiate a game play. In an illustrative embodiment, the request can include a selection by a player of a button, touch-screen control, or other control device that indicates a desire to initiate a game play at the apparatus. In another illustrative embodiment, the request can include the gaming apparatus reading a magnetic card, smart card, or other card of the player. In yet another embodiment, the request can include coins, paper currency, or any combination thereof, being inserted into a currency receipt device of the gaming apparatus.

Moving to block 602, the gaming apparatus receives a plurality of wagers from the player. In a particular embodiment, the gaming apparatus can display a prompt to input wagers at a display device of the gaming apparatus. Continuing to decision step 604, the gaming apparatus determines whether a number or total value of wagers required to play a game has been received. If the required number or total value of wagers has not been received, additional wagers are required and the method proceeds to block 606, and the gaming apparatus prompts the player to input additional wagers. On the other hand, if the required number or total value of wagers has been received, the method advances to block 608.

At block 608, a game play associated with the wagers input by the player is initiated. In a particular embodiment, the gaming apparatus can initiate the game play when the required number or total value of wagers is received. In another embodiment, the player can select a ‘PLAY’ button, touch-screen control, or other control device of the gaming apparatus that indicates the player's desire to initiate the game play. Moving to block 610, the gaming apparatus determines an outcome of the game play. In an illustrative embodiment, the gaming apparatus can determine the outcome of the game play randomly from a plurality of possible outcomes. In another illustrative embodiment, the gaming apparatus can determine the game play outcome according to pre-determined frequencies associated with a plurality of possible game play outcomes.

Proceeding to block 612, the gaming apparatus displays the game play outcome to the player. At decision step 614, in a particular embodiment, the gaming apparatus can determine whether the game play outcome includes a prize event. If the game play outcome does not include a prize event, the method advances to decision step 620 and continues. Conversely, if a prize event has occurred, the method moves to block 616, and the gaming apparatus indicates that a prize event has occurred. For example, the gaming apparatus can display a prize event indicator on a user interface displayed at the display device. In another example, the gaming apparatus can activate a prize event indicator, such as a light, bell, siren, light-emitting diode (LED) device, other prize event indicator, or any combination thereof.

When a prize event occurs, the method advances to block 618, and the gaming apparatus outputs prizes associated with the particular prize event. In an illustrative embodiment, the gaming apparatus can output the prizes by dispensing coins or other currency via a currency output device; by transferring funds, credits, or other prize units to a player account associated with a magnetic card, smart card, or other card of the player; or any combination thereof. In an illustrative embodiment, a prize event can be one of a plurality of prize events. The prizes associated with separate prize events, or with separate groups of prize events, can vary, such that not all prize events output prizes of equal value.

In a particular embodiment, the prizes output by the gaming apparatus comply with a prize constraint limit. In an illustrative embodiment, the prize constraint limit can limit the value of the prizes to a maximum multiple of the value of each of the plurality of wagers, such as a multiple of ten. Nonetheless, the gaming apparatus can provide a prize structure that is representative of a modeled prize structure of an apparatus that does not comply with the prize constraint limit, such as a single wager gaming apparatus having a modeled prize structure that is not realizable by a single wager gaming apparatus within the prize constraint limit. In one embodiment, the gaming apparatus can provide such a prize structure using a plurality of wagers and a guaranteed non-zero return.

For example, at blocks 602-606, the gaming apparatus can require twenty-eight coins for a game play, each of the coins representing a separate wager associated with the game play. The prizes output by the gaming apparatus can have a prize structure such as that illustrated in FIG. 2. Thus, when the gaming apparatus outputs its highest output of two hundred seventy-seven quarters, the gaming apparatus returns fewer than ten coins for any single wager. Nonetheless, the frequencies of particular prizes output by the gaming apparatus within a pool of game plays and the coins retained by the gaming apparatus per pool of game plays resembles the prize structure of a gaming apparatus that is not subject to the prize constraint limit, such as the prize structure illustrated in FIG. 1.

In an illustrative embodiment, the structure of prizes output by the gaming apparatus can resemble that of a single wager gaming apparatus having the modeled prize structure illustrated in FIG. 1, when the gaming apparatus provides a non-zero return equal to all but one of the wagers associated with a game play. For instance, one or more particular game play outcomes can output a pay amount of twenty-seven coins. Hence, the totality of prizes output by the gaming apparatus can have a prize structure that is representative of a modeled prize structure of a single wager gaming apparatus having a modeled prize structure such as that illustrated in FIG. 1, yet none of the prizes output by the gaming apparatus exceeds the prize constraint limit of ten times any single wager.

In an illustrative embodiment, the prizes output by the gaming apparatus can also comply with a maximum per wager limit value that restricts the value of prizes returned by the gaming apparatus for any single wager. For example, the maximum per wager limit value can limit prizes output by the gaming apparatus to a maximum value of five dollars ($5.00), per wager. When a game play outcome occurs that is associated with pay amounts totaling one hundred two quarters or two hundred seventy-seven quarters, for instance, the total value of the prize exceeds five dollars, but the prize does not exceed the maximum per wager limit value of five dollars for any single wager.

Proceeding to decision step 620, the gaming apparatus can determine whether the player desires to initiate another game play at the gaming apparatus. For example, the gaming apparatus can display a prompt asking the player to indicate whether another game play is desired. If the player wishes to initiate another game play, the method returns to block 602. Conversely, if the player does not wish to initiate another game play, the method terminates at 622.

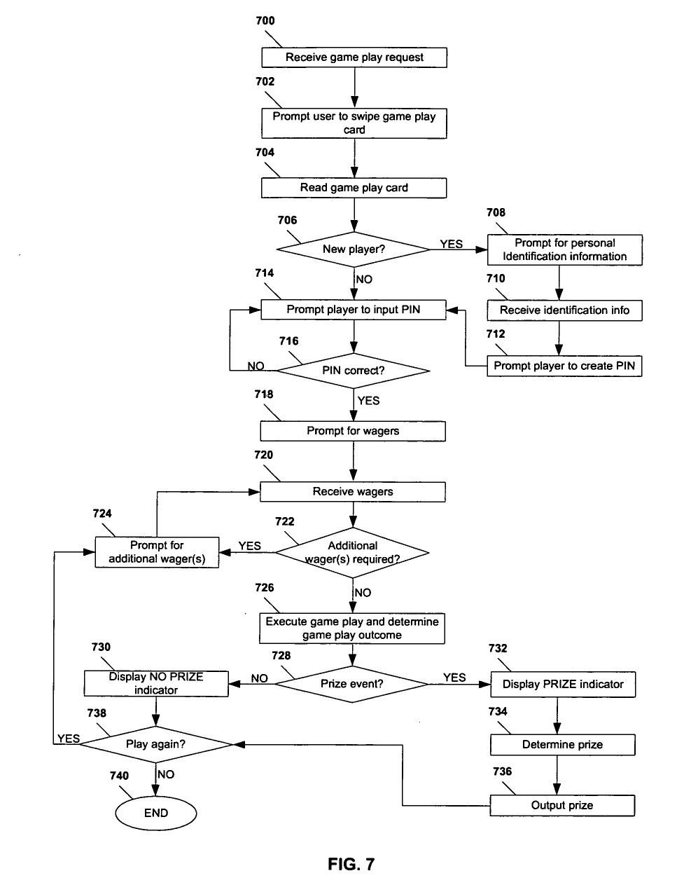

Referring to FIG. 7, a second particular embodiment of a method of operating a gaming apparatus is illustrated. At block 700, a request is received at a gaming apparatus to initiate a game play. In an illustrative embodiment, the request can include a selection by a player of a button, touch-screen control, or other control device that indicates a desire to initiate a game play at the apparatus. In another illustrative embodiment, the request can include the gaming apparatus reading a card reader of the gaming apparatus and a magnetic card, smart card, or other card of the player. In yet another embodiment, the request can include coins, paper currency, or any combination thereof, being inserted into a currency receipt device of the gaming apparatus.

Moving to block 702, the gaming apparatus prompts the player to swipe or otherwise provide a player card to be read via a card-reading device of the gaming apparatus. The player card can be a credit card, retailer card, a player card associated with the gaming apparatus or a game operator, or other magnetic card or smart card. Continuing to block 704, the gaming apparatus reads a magnetic strip or stored data of the player card. In a particular embodiment, the gaming apparatus can use information or data read or otherwise acquired from the card to access account information or other information associated with the player from remote systems or locations via a communications interface, such as a network interface.

In an illustrative, non-limiting embodiment, the method proceeds to decision step 706, and the gaming apparatus determines whether the player card is associated with a player that has played one or more games at the gaming apparatus, at a gaming operator site, at gaming operator machines, or any combination thereof. If the player card is associated with a recognized player, the method advances to block 714, and the gaming apparatus prompts the player to enter a previously selected or assigned authentication token, such as a personal identification number (PIN) or other authentication token. In an illustrative embodiment, the gaming apparatus can display an authentication screen, such as a login screen that prompts the player to enter the authentication token.

Conversely, if the player is a new player, the method moves to block 708. At block 708, in a particular embodiment, the gaming apparatus can prompt the player to swipe or otherwise provide an identity verification card, such as a driver's license having a magnetic strip or stored data, a credit card, or other identification card, to be read via the card reader. Proceeding to block 710, the gaming apparatus receives identification information from the identification card or from a system that the gaming apparatus accesses using information read or otherwise acquired from the card. In a particular embodiment, the gaming apparatus can verify identification information associated with the player, such as verifying that the player is of legal gambling age, comparing a photograph on the identification card with an image of the player recorded by the gaming apparatus or other security device, verifying other identification information, or any combination thereof. Continuing to block 712, the gaming apparatus can prompt the player to input an authentication token, such as a PIN. Alternatively, the gaming apparatus can assign a PIN or other authentication token to the player. In a particular embodiment, the method then proceeds to block 714, and the player is prompted to enter the PIN or other authentication token.

At decision step 716, the gaming apparatus determines whether the PIN or other authentication token entered by the player matches a PIN or other authentication token associated with the player. For example, the PIN or other authentication token can be stored and associated with the player in a non-volatile memory device of the gaming apparatus or at a remote system with which the gaming apparatus communicates. If the PIN or other authentication token entered by the player is not correct, the method returns to block 714. On the other hand, if the PIN or other authentication token entered by the player is correct, the method proceeds to block 718.

At block 718, in an illustrative embodiment, the gaming apparatus prompts the player to input a plurality of wagers required to play a game. Moving to block 720, the gaming apparatus receives the wagers from the player. The wagers can be received via an account associated with the player card or another card of the player; via a coin receipt device; via a paper currency receipt device; or any combination thereof. Continuing to decision step 722, the gaming apparatus determines whether a number or total value of wagers required for a game play has been received. If the required number or total value of wagers has not been received, the method proceeds to block 724, and the gaming apparatus prompts the player to input additional wagers. On the other hand, if the required number or total value of wagers has been received, the method advances to block 726.

At block 726, a game play associated with the wagers input begins and the gaming apparatus determines an outcome of the game play. In a particular embodiment, the gaming apparatus can initiate the game play when the required number or total value of wagers is received. In another embodiment, the player can select a button, touch-screen control, or other control device of the gaming apparatus that indicates the player's desire to initiate the game play. In an illustrative embodiment, the gaming apparatus can determine the outcome of the game play randomly from a plurality of possible outcomes. In another illustrative embodiment, the gaming apparatus can determine the game play outcome according to pre-determined frequencies associated with each possible game play outcome within a pool of game plays.

Proceeding to block 728, in a particular embodiment, the gaming apparatus can determine whether the game play outcome includes a prize event. If the game play outcome does not include a prize event, the method advances to decision step 730, and the gaming apparatus can display a ‘NO PRIZE’ indicator via a user interface or other display at the display device, or at a light, LED, or other indicator of the gaming apparatus. The method then moves to decision step 738.

Returning to decision step 728, if a prize event has occurred, the method moves to block 732, and the gaming apparatus indicates that a prize event has occurred. For example, the gaming apparatus can display a prize event indicator on a user interface displayed at the display device. In another example, the gaming apparatus can activate a prize event indicator, such as a light, bell, siren, light-emitting diode (LED) device, other prize event indicator, or any combination thereof.

The method advances to block 734, and the gaming apparatus determines prizes associated with the prize event. A prize event can be one of a plurality of prize events. The prizes associated with separate prize events, or with separate groups of prize events, can vary, such that not all prize events output prizes of equal value. Further, the plurality of prize events can include at least one special prize event, such as a ‘jackpot’ prize event. In an illustrative embodiment, the gaming apparatus can calculate the prizes by applying formulae to a game play outcome, such as a number of links of one or more types multiplied by a payoff per link of each type.

Proceeding to block 736, the gaming apparatus outputs the determined prizes. The gaming apparatus can output the prizes by dispensing coins or other currency via a currency output device; by transferring funds, credits, or other prize units to a player account associated with a magnetic card, smart card, or other card of the player; or any combination thereof.

In a particular embodiment, the prizes output by the gaming apparatus comply with a prize constraint limit. In an illustrative embodiment, the prize constraint limit can limit the value of the prizes to a maximum multiple of the value of each of the plurality of wagers, such as a multiple often. Nonetheless, the gaming apparatus can provide a prize structure that is representative of a modeled prize structure of an apparatus that does not comply with the prize constraint limit, such as a single wager gaming apparatus having a modeled prize structure that is not realizable by a single wager gaming apparatus within the prize constraint limit. In one embodiment, the gaming apparatus can provide such a prize structure using a plurality of wagers and a guaranteed non-zero return.

For example, the gaming apparatus can require twenty-eight coins for a game play, each of the coins representing a separate wager associated with the game play. The prizes output by the gaming apparatus can have a prize structure such as that illustrated in FIG. 2. Thus, when the gaming apparatus outputs its highest output of two hundred seventy-seven quarters, the gaming apparatus returns fewer than ten coins for any single wager. Nonetheless, the frequencies of particular prizes output by the gaming apparatus within a pool of game plays and the coins retained by the gaming apparatus per pool of game plays resembles the prize structure of a gaming apparatus that is not subject to the prize constraint limit, such as the prize structure illustrated in FIG. 1.

In an illustrative embodiment, the structure of prizes output by the gaming apparatus can resemble that of a single wager gaming apparatus having the modeled prize structure illustrated in FIG. 1, when the gaming apparatus provides a non-zero return equal to all but one of the wagers associated with a game play. For instance, one or more particular game play outcomes can output a pay amount of twenty-seven coins. Hence, the totality of prizes output by the gaming apparatus can have a prize structure that is representative of a modeled prize structure of a single wager gaming apparatus having a modeled prize structure such as that illustrated in FIG. 1, yet none of the prizes output by the gaming apparatus exceeds the prize constraint of ten times any single wager.

In an illustrative embodiment, the prizes output by the gaming apparatus can also comply with a maximum per wager limit value that restricts the value of prizes returned by the gaming apparatus any single wager. For example, the maximum per wager limit value can limit prizes output by the gaming apparatus to a maximum value of five dollars ($5.00), per wager. When a game play outcome occurs that is associated with pay amounts totaling one hundred two quarters or two hundred seventy-seven quarters, for instance, the total value of the prize exceeds five dollars, but the prize does not exceed the maximum per wager limit value of five dollars for any single wager.

Proceeding to decision step 738, the gaming apparatus can determine whether the player desires to initiate another game play at the gaming apparatus. For example, the gaming apparatus can display a prompt asking the player to indicate whether another game play is desired. If the player wishes to initiate another game play, the method returns to block 724. Conversely, if the player does not wish to initiate another game play, the method terminates at 740.

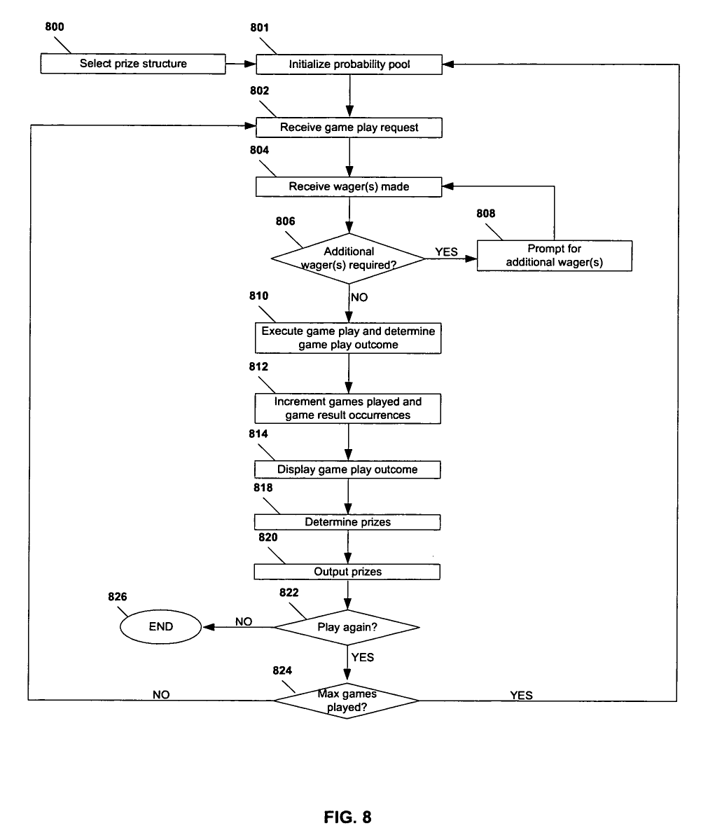

Referring to FIG. 8, a third particular embodiment of a method of operating a gaming apparatus is illustrated. At block 800, in an illustrative, non-limiting embodiment, a prize structure can be selected from a plurality of prize structures. For example, a game operator or administrator can select a prize structure from a first modeled prize structure, such as the prize structure illustrated in FIG. 2; a second modeled prize structure, such as a prize structure having only one prize event; another modeled prize structure; an arbitrary prize structure; or any combination thereof. In another particular embodiment, a player may be presented with an option to select the prize structure followed by the gaming apparatus during a game play.

Moving block 801, the gaming apparatus initializes a probability pool associated with the selected prize structure. For example, the gaming apparatus can store data indicating that each of the game play outcomes is to occur a specified number of times within a designated total number of game plays. The gaming apparatus can record the occurrence of each game play outcome and increment by one the total number of game plays after each game play at the gaming apparatus. In an illustrative embodiment, the gaming apparatus can initialize a probability pool associated with a game by setting the number of game plays to zero out of a maximum number of game plays, and the number of occurrences of each game play outcome to zero out of a maximum number of occurrences within the maximum number of game plays. The maximum number of occurrences of each game play outcome can be different than that of each other game play outcome, different than that of some other game play outcomes, the same as one or more other game play outcomes, or any combination thereof. Initialization can be performed upon powering up the gaming apparatus, after a maximum number of game plays, after a certain prize event, such as a payout of a largest prize amount, after another initialization event, or any combination thereof.

Continuing to block 802, a request is received at the gaming apparatus to initiate a game play. In an illustrative embodiment, the request can include a selection by a player of a button, touch-screen control, or other control device that indicates a desire to initiate a game play at the apparatus. In another illustrative embodiment, the request can include the gaming apparatus reading a magnetic card, smart card, or other card of the player. In yet another embodiment, the request can include coins, paper currency, or any combination thereof, being inserted into a currency receipt device of the gaming apparatus.

Proceeding to block 804, in a particular embodiment, the gaming apparatus receives wagers from the player. In a particular embodiment, the gaming apparatus can display a prompt to input wagers at a display device of the gaming apparatus. The wagers can be received via an account associated with the player card or another card of the player; via a coin receipt device; via a paper currency receipt device; or any combination thereof. Continuing to decision step 806, the gaming apparatus determines whether a number or total value of wagers required for a game play has been received. If the required number or total value of wagers has not been received, the method proceeds to block 808, and the gaming apparatus prompts the player to input additional wagers. On the other hand, if the required number or total value of wagers has been received, the method advances to block 810.

At block 810, a game play associated with the wagers begins and the gaming apparatus determines an outcome of the game play. In a particular embodiment, the gaming apparatus can start the game play when the required number or total value of wagers is received. In another embodiment, the player can select a button, touch-screen control, or other control device of the gaming apparatus that indicates the player's desire to start the game play. The gaming apparatus can determine the game play outcome according to pre-determined frequencies associated with each possible game play outcome within a pool of game plays.

Proceeding to block 812, in a particular embodiment, the gaming apparatus can increment by one the total number of game plays since initialization. The gaming apparatus can also increment the number of occurrences of the determined game play outcome by one. In another embodiment, the gaming apparatus can decrement a number of game plays remaining before initialization by one and can decrement a number of occurrences of the game play remaining within the remaining number of game plays by one.

Continuing to block 814, the gaming apparatus can display the game play outcome. In an illustrative, non-limiting embodiment, the game play outcome can correspond to a number of squares having a first color, a number of squares having a second color, a number of links having a first color, a number of links having a second color, a number of links having a third color, or any combination thereof. A graphical user interface to display the game play outcome is illustrated in FIG. 10.

The method advances to block 818, and the gaming apparatus determines prizes associated with the game play outcome. In an illustrative embodiment, a prize event can be one of a plurality of prize events. The prizes associated with separate prize events, or with separate groups of prize events, can vary, such that not all prize events output prizes of equal value. Further, the plurality of prize events can include a prize event, such as all squares being red, all squares being black, another distribution of red and black squares, or any combination thereof. In an illustrative embodiment, the gaming apparatus can calculate the prizes by applying formulae to a game play outcome, such as a number of links of one or more colors multiplied by a same or different payoff per link related to each color.

Proceeding to block 820, the gaming apparatus outputs the determined prizes. The gaming apparatus can output the prizes by dispensing coins or other currency via a currency output device; by transferring funds, credits, or other prize units to a player account associated with a magnetic card, smart card, or other card of the player; or any combination thereof.

In a particular embodiment, the prizes output by the gaming apparatus comply with a prize constraint limit. In an illustrative embodiment, the prize constraint limit can limit the value of the prizes to a maximum multiple of the value of each of the plurality of wagers, such as a multiple of ten. Nonetheless, the gaming apparatus can provide a prize structure that is representative of a modeled prize structure of an apparatus that does not comply with the prize constraint limit, such as a single wager gaming apparatus having a modeled prize structure that is not realizable by a single wager gaming apparatus within the prize constraint limit. In one embodiment, the gaming apparatus can provide such a prize structure using a plurality of wagers and a guaranteed non-zero return.

For example, the gaming apparatus can require twenty-eight coins for a game play, each of the coins representing a separate wager associated with the game play. The prizes output by the gaming apparatus can have a prize structure such as that illustrated in FIG. 2. Thus, when the gaming apparatus outputs its highest output of two hundred seventy-seven quarters, the gaming apparatus returns fewer than ten coins for any single wager. Nonetheless, the frequencies of particular prizes output by the gaming apparatus within a pool of game plays and the coins retained by the gaming apparatus per pool of game plays resembles the prize structure of a gaming apparatus that is not subject to the prize constraint limit, such as the prize structure illustrated in FIG. 1.

In an illustrative embodiment, the structure of prizes output by the gaming apparatus can resemble that of a single wager gaming apparatus having the modeled prize structure illustrated in FIG. 1, when the gaming apparatus guarantees a non-zero return equal to all but one of the wagers associated with a game play. For instance, one or more particular game play outcomes can output a pay amount of twenty-seven coins. Hence, the totality of prizes output by the gaming apparatus can have a prize structure that is representative of a modeled prize structure of a single wager gaming apparatus having a modeled prize structure such as that illustrated in FIG. 1, yet none of the prizes output by the gaming apparatus exceeds the prize constraint of ten times any single wager.

In an illustrative embodiment, the prizes output by the gaming apparatus can also comply with a maximum per wager limit value that restricts the value of prizes returned by the gaming apparatus for any single wager. For example, the maximum per wager limit value can limit prizes output by the gaming apparatus to a maximum value of five dollars ($5.00), per wager. When a game play outcome occurs that is associated with pay amounts totaling one hundred two quarters or two hundred seventy-seven quarters, for instance, the total value of the prize exceeds five dollars, but the prize does not exceed the maximum per wager limit value of five dollars for any single wager.

Moving to decision step 822, the gaming apparatus can determine whether the player desires to initiate another game play at the gaming apparatus. For example, the gaming apparatus can display a prompt asking the player to indicate whether another game play is desired. If the player does not wish to initiate another game play, the method terminates at 826. Conversely, if the player wishes to initiate another game play, the method advances to decision step 824. At decision step 824, the gaming apparatus determines whether a maximum number of game plays has occurred since initialization. If the maximum number of game plays has not occurred, the method returns to block 802 and continues as described above. On the other hand, if the maximum number of game plays has occurred, the method returns to block 801 and continues as described above.

In a particular embodiment, the steps of the methods described herein are executed in the order shown by the figures. In alternative embodiments, the steps may be executed in alternative sequences.

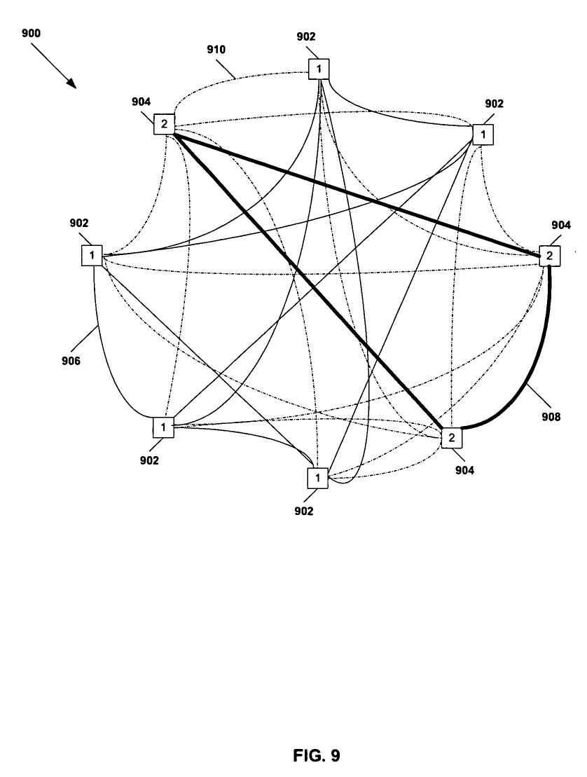

Referring to FIG. 9, a diagram of an illustrative embodiment of nodes and links related to an example game play outcome is illustrated and designated generally at 900. In the example illustrated, the game play outcome includes a plurality of squares 902, 904. The squares 902, 904 can include zero or more first squares 902 having a first color and zero or more second squares 904 having a second color.

In a particular embodiment, the game play outcome can include links among the squares. For example, the game play outcome can include zero or more first links 906, each of which links two first squares 902. The game play outcome can also include zero or more second links 908, each of which connects two squares having the second colors 904. Further, the game play outcome can include zero or more third links 910, each of which links a first square 902 with a second square 904.

In a particular embodiment, a plurality of wagers is associated with a game play, such as one coin wagered on each of the twenty-eight links. Pay amounts can be calculated based on a payoff per link of each color or type.

Referring to FIG. 10, an illustrative embodiment of a graphical user interface to show a game play outcome is illustrated and designated 1000. The graphical user interface (GUI) 1000 can be a video interface that includes one or more video representations of reels 1001 of a slot machine, for example. Further, in a particular embodiment, the GUI 1000 can also include a representation of nodes and links 1002 on which payouts are based and which is mapped to results displayed by the video reels 1001 for a game play outcome. In addition, the GUI 1000 can include various controls 1003-1009 that can be selected by a player via a touch-screen or via other controls of an apparatus displaying the GUI 1000.

For example, the GUI 1000 can include a ‘BET ONE’ control 1003 that a player can select to make a single wager associated with all links. In another embodiment, the GUI 1000 can include a ‘BET MAX’ control 1004 that a player can select to make a plurality of wagers, such as a single wager for each link. In an illustrative embodiment, the GUI 1000 can include informational controls 1005, such as a control that causes the GUI 1000 to display ‘HELP’ information or a control that causes the GUI 1000 to display ‘PAYTABLE’ information.

In a particular embodiment, the GUI 1000 can include a ‘SPIN’ control 1006 or similar control that a player can select to initiate a game play. Further, the GUI 1000 can include one or more indicators 1007, such as a ‘WIN’ indicator that indicates a prize event; a ‘BET’ indicator that indicates that additional wagers are required for a game play or that shows wagers associated with a game play; or a ‘CREDITS’ indicator or similar indicator that shows coins, credits, or other amounts allotted to a player during a gaming session, for example. In addition, the GUI 1000 can include a denomination indicator 1008 that shows the denomination of each wager, for example, made for a game play. Moreover, the GUI 1000 can include increase/decrease controls 1009 to increase or decrease the denomination shown by the denomination indicator 1008.

The GUI 1000 illustrated in FIG. 10 is provided for illustrative purposes only. Those skilled in the art will readily ascertain that many various user interfaces, both video and mechanical, can be used to provide a system or method as described with reference to FIGS. 1-9.

In accordance with various embodiments, the methods described herein can be implemented as one or more software programs running on a computer processor. Dedicated hardware implementations including, but not limited to, application specific integrated circuits, programmable logic arrays, gaming apparatus hardware and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, SSL) represent examples of the state of the art. Such standards are periodically superseded by faster or more efficient equivalents having essentially the same functions. Accordingly, replacement standards and protocols having the same or similar functions as those disclosed herein, such as communication with accounts via communications interfaces, are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of operating a gaming apparatus, the method comprising:
receiving a plurality of wagers made;
determining whether a prize event has occurred based on an outcome of a game play associated with the plurality of wagers made;
outputting prizes when the prize event occurs;
wherein, in some cases, a total value of the prizes is greater than a maximum per wager limit value;
wherein each of the prizes complies with a prize constraint limit; and
wherein a totality of the prizes has a prize structure that is representative of a modeled prize structure of an apparatus that exceeds the prize constraint limit on a per wager basis.

2. The method of claim 1, further comprising:
allowing the player to purchase insurance which protects the player from losing more than a specified amount on a single event of simultaneous outcomes;

3. The method of claim 1, wherein the modeled prize structure is based on a prize structure of a single wager gaming machine that does not comply with the prize constraint limit.

4. The method of claim 3, wherein the prize structure of the single wager gaming machine is not realizable within the prize constraint limit.

5. The method of claim 1, wherein the prize structure may be modified to represent an arbitrary prize structure.

6. The method of claim 1, further comprising modifying the prize structure to represent a second modeled prize structure.

7. The method of claim 1, wherein the prize structure provides a guaranteed non-zero return.

8. The method of claim 7, wherein the guaranteed non-zero return has a value of at least one of the plurality of wagers made.

9. The method of claim 7, wherein the guaranteed non-zero return has a value equal to all but one of the plurality of wagers made.

10. The method of claim 1, wherein the prize structure replicates the modeled prize structure.

11. A gaming apparatus, comprising:
a wager input device to receive a plurality of wagers made;
a processor and a memory device accessible to the processor, wherein the memory device includes instructions executable by the processor to determine whether a prize event has occurred based on an outcome of a game play associated with the plurality of wagers made;
wherein the memory device includes instructions to output prizes via a prize output device when the prize event occurs, each of the prizes complying with a prize constraint limit;
wherein, in some cases, a total value of the prizes is greater than a maximum per wager limit value; and
wherein a totality of the prizes has a prize structure that is representative of a modeled prize structure of an apparatus that exceeds the prize constraint limit on a per wager basis.

12. The gaming apparatus of claim 11, wherein the wager input device includes a coin input device, a paper currency input device, a communications interface, or any combination thereof.

13. The gaming apparatus of claim 12, further comprising a card reading device and wherein at least one of the plurality of wagers made is received via the communications interface from a player account associated with a card read via the card-reading device.

14. The gaming apparatus of claim 11, wherein the at least one prize output device includes a coin output device, a paper currency output device, a communications interface, or any combination thereof.

15. The gaming apparatus of claim 14, further comprising a card-reading device and wherein the prizes are output via the communications interface to a player account associated with a card read via the card-reading device.

16. The gaming apparatus of claim 11, further comprising a display system having a video controller and a display screen to display the outcome of the game play.

17. The gaming apparatus of claim 16, wherein the display screen displays the game play, information related to a game, advertising information, a prize indicator, a no-prize indicator, a prompt to input wagers, or any combination thereof.

18. The gaming apparatus of claim 11, further comprising a plurality of controls and wherein the memory device includes instructions executable by the processor to perform at least one of starting a game session, ending a game session, starting a game play, stopping a game play, displaying information related to a game, receiving the plurality of wagers made, or any combination thereof, in response to the plurality of controls.

19. The gaming apparatus of claim 18, wherein the plurality of controls include at least one selectable button.

20. The gaming apparatus of claim 18, wherein the plurality of controls include at least one selectable touch-screen control displayed on a display device of the gaming apparatus.

21. A computer program embedded within a computer-readable medium, the computer program comprising:
instructions to associate a plurality of wagers made with a game play, wherein the plurality of wagers is received via a wager input device of a gaming apparatus;
instructions to determine whether a prize event has occurred based on an outcome of the game play;
instructions to output prizes via a prize output device of the gaming apparatus when the prize event occurs, each of the prizes complying with a prize constraint limit;
wherein, in some cases, a total value of the prizes is greater than a maximum per wager limit value; and
wherein a totality of the prizes has a prize structure that is representative of a modeled prize structure of an apparatus that exceeds the prize constraint limit on a per wager basis.

22. The computer program of claim 21, further comprising instructions to initialize a probability pool associated with a plurality of possible game play outcomes after an initialization condition has occurred.

23. The computer program of claim 22, wherein:
a number of game plays is set to zero and a number of occurrences of each of the plurality of possible game play outcomes is set to zero;
the number of game plays is incremented by one after the game play and the number of occurrences of the outcome of the game play is incremented by one after the game play; and
an initialization condition occurs when the number of game plays is equal to a maximum number of game plays.

24. The computer program of claim 22, wherein:
a number of game plays is set to a maximum number of game plays and a number of occurrences of each of the plurality of possible game play outcomes is set to one of at least one maximum number of occurrences;
the number of game plays is decremented by one after the game play and the number of occurrences of the outcome of the game play is decremented by one after the game play; and
an initialization condition occurs when the number of game plays is equal to zero.

25. The computer program of claim 22, wherein an initialization condition occurs when the gaming apparatus is powered on, when a particular prize event occurs, when an initialization command is received at the gaming apparatus, or any combination thereof.

26. The computer program of claim 21, wherein:
the outcome of the game play includes zero or more first squares having a first color, zero or more second squares having a second color, or any combination thereof; and
a prize event occurs when the outcome of the game play includes at least one pre-defined distribution of first squares, second squares, or any combination thereof.

27. The computer program of claim 26, wherein:
the outcome of the game play includes zero or more first links, each first link having the first color and linking two first squares;
the outcome of the game play includes zero or more second links, each second link having the second color and linking two second squares; and
a prize event occurs when the outcome of the game play includes at least one pre-defined distribution of first links, second links, or any combination thereof.

28. The computer program of claim 21, further comprising:
instructions to read data from a card of a player via a card reading device of the gaming apparatus;
instructions to determine whether the player is a new player based on the data; and
instructions to prompt the player to input an authentication token.

29. The computer program of claim 28, further comprising instructions to prompt the player to create an authentication token when the player is a new player.

30. The computer program of claim 29, further comprising prompting the new player to enter identification information and verifying the identity, age, prohibited player status, or any combination thereof, of the new player prior to prompting the player to create the authentication token.

31. The computer program of claim 30, further comprising receiving the identification information via an identification card read by the card reading device.

32. A gaming apparatus, comprising:
a wager input device to receive a plurality of wagers made;
a controller coupled to the wager input device;
wherein the controller determines whether a prize event has occurred based on an outcome of a game play associated with the plurality of wagers made;
wherein the controller outputs prizes via a prize output device when the prize event occurs, each of the prizes complying with a prize constraint limit;
wherein, in some cases, a total value of the prizes is greater than a maximum per wager limit value; and
wherein a totality of the prizes has a prize structure that is representative of a modeled prize structure of an apparatus that exceeds the prize constraint limit on a per wager basis.
